(19) United States
(12) Patent Application Publication
(10) Pub. No.: US 2021/0089685 A1
(43) Pub. Date: Mar. 25, 2021

(54) MONITORING MEMORY STATUS USING CONFIGURABLE HARDWARE SECURED BY A DICE ROOT OF TRUST

(71) Applicant: Intel Corporation, Santa Clara, CA (US)

(72) Inventors: Sunil Cheruvu, Tempe, AZ (US); Ned M. Smith, Beaverton, OR (US); Kshitij Arun Doshi, Tempe, AZ (US)

(21) Appl. No.: 17/100,580

(22) Filed: Nov. 20, 2020

Related U.S. Application Data
(60) Provisional application No. 62/939,217, filed on Nov. 22, 2019.

(51) Int. Cl. G06F 21/79; G06F 21/57; G06F 21/54; G06F 12/14; G06F 11/30

(52) U.S. Cl. CPC G06F 21/79; G06F 21/572; G06F 11/3037; G06F 12/1416; G06F 21/54

(57) ABSTRACT

Methods, systems, and use cases for verifying operations of trusted hardware, such as with a memory monitor, are disclosed, with implementation in a computing system. In an example, a computing system includes memory circuitry including a DRAM device, processing circuitry operably coupled to the DRAM device, and a field programmable gate array (FPGA) configured to install and provision a memory monitor. The memory monitor is provided from an external verifier entity, and the memory monitor is operated by the FPGA to monitor operations of the DRAM device. The FPGA includes a Root of Trust (RoT) hardware component that is compliant with a Device Identifier Composition Engine (DICE) trusted computing specification, and DICE attestation using the RoT hardware component is used to verify a secure state of the memory monitor with the verifier entity, during operation of the memory monitor.

### PRIORITY CLAIM

This application claims the benefit of priority to U.S. Provisional Patent Application No. 62/939,217, filed Nov. 22, 2019, and titled “MONITORING MEMORY STATUS USING CONFIGURABLE HARDWARE SECURED BY A DICE ROOT OF TRUST”, which is incorporated by reference herein in its entirety.

### TECHNICAL FIELD

Embodiments described herein generally relate to data processing, security and attestation techniques, and computing hardware configurations, and in particular, to monitoring memory contents and computing operation states using a configurable monitor providing operation according to a hardware-based root of trust (RoT) established according to a Device Identifier Composition Engine (DICE) security standard.

### BACKGROUND

Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

Edge computing use cases in mobile network settings have been developed for integration with multi-access edge computing (MEC) approaches, also known as “mobile edge computing.” MEC approaches are designed to allow application developers and content providers to access computing capabilities and an information technology (IT) service environment in dynamic mobile network settings at the edge of the network. Limited standards have been developed by the European Telecommunications Standards Institute (ETSI) industry specification group (ISG) in an attempt to define common interfaces for operation of MEC systems, platforms, hosts, services, and applications.

Edge computing, MEC, and related technologies attempt to provide reduced latency, increased responsiveness, and more available computing power than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (devices, hosts, tenants, service providers, operators) are involved.

In a similar manner, Internet of Things (IoT) networks and devices are designed to offer a distributed compute arrangement, from a variety of endpoints. IoT devices are physical or virtualized objects that may communicate on a network, and may include sensors, actuators, and other input/output components, which may be used to collect data or perform actions in a real world environment. For example, IoT devices may include low-powered endpoint devices that are embedded or attached to everyday things, such as buildings, vehicles, packages, etc., to provide an additional level of artificial sensory perception of those things. Recently, IoT devices have become more popular and thus applications using these devices have proliferated.

The deployment of various Edge, Fog, MEC, and IoT networks, devices, and services have introduced a number of advanced use cases and scenarios occurring at and towards the edge of the network. However, these advanced use cases have also introduced a number of corresponding technical challenges relating to security, processing and network resources, service availability and efficiency, among many other issues, especially as more types of computing systems and configurations are deployed. One such challenge is in relation to security and trust, and the operational states of software programs and data, as represented in memory (e.g., DRAM memory), cache memory (e.g., in a cache), or registers (e.g., CPU, or GPU).

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing, according to an example;

FIG. 2 illustrates deployment and orchestration for virtual edge configurations across an edge computing system operated among multiple edge nodes and multiple tenants, according to an example;

FIG. 3 illustrates a vehicle compute and communication use case involving mobile access to applications in an edge computing system, according to an example;

FIG. 4 illustrates a block diagram depicting deployment and communications among a number of Internet of Things (IoT) devices, according to an example;

FIG. 5 illustrates an overview of layers of distributed compute deployed among an edge computing system, according to an example;

FIG. 6A illustrates an overview of example components deployed at a compute node system, according to an example;

FIG. 6B illustrates a further overview of example components within a computing device, according to an example;

FIG. 7 illustrates a block diagram depicting an overview of a computing system architecture, supporting memory management operations, according to an example;

FIG. 8 illustrates a block diagram depicting an overview of a computing system architecture, supporting memory management operations from a verified trusted memory monitor, according to an example;

FIG. 9 illustrates a flow of an example process for attesting and verifying a monitoring component used for monitoring memory status, according to an example;

FIG. 10 illustrates a block diagram depicting an overview of a computing system architecture, supporting memory management operations with a memory controller, according to an example;

FIG. 11 illustrates a flowchart of an example method for deploying a trusted memory monitor and monitoring memory status with the trusted memory monitor, according to an example; and

FIGS. 12A and 12B illustrate further memory monitoring approaches, according to additional examples.

### DETAILED DESCRIPTION

In the following description, methods, configurations, and related apparatuses are disclosed for monitoring of memory status, using a DICE-based root of trust in configurable hardware, such as with the use of a configurable field-programmable gate array (FPGA), memory controller, or like configurable component. The following examples introduce operations performed by a verifier (e.g., by a cloud- or edge-connected entity) which can install, control, and oversee a monitor (e.g., implemented by a FPGA design) on the configurable hardware (e.g., FPGA, memory controller, etc.). For instance, the monitor may perform internal monitoring and processing of a DRAM status, while also attesting to the trustworthiness of the monitor (e.g., a “trusted monitor” as implemented in a FPGA design) that performs the local processing of the DRAM telemetry. These examples enable increased security, reliability, and control of monitoring operations.

Applicability of Memory Monitoring and DICE RoT Management

The present techniques for monitoring and security may be coordinated in a variety of device and computing system deployment environments involving edge computing/edge cloud deployments, Internet of Things (IoT) networks, Multi-Access Edge Computing (MEC) systems, network function virtualization (NFV) implementations, and other aspects of networking and computing technologies.

One of the challenges associated with Edge Node operation is the possibility of runtime attacks on Edge node platforms due to a lack of sophisticated physical security that is common in Cloud node environments (e.g., secured data centers). Runtime attacks threaten memory, cache, and persistent memory technologies used during runtimes, whether the form of Intel® 3D XPoint memory, Optane memory, as well as DRAM, FLASH and other memory and memory storage technologies.

A possible countermeasure to runtime attacks involves the monitoring of memory/storage resources during execution. This involves high speed, non-invasive techniques for trustworthy sampling memory contents and comparing contents to expected values. (Or, trustworthy computation of measurements and comparison of measurements to expected values). With the present techniques, such monitoring is enabled, launched, verified, operated, and updated in a secure way.

In a specific example, the following techniques enable monitoring of a DRAM using an FPGA that has a native Trusted Computing Base and a monitoring algorithm. This monitoring algorithm, further referred to herein as a “Trusted Memory Monitor” (TMM) is used to ensure that unauthorized modification of runtime edge node memory can be detected. The FPGA uses an integrated hardware root of trust based on a Device Identity Composition Engine (DICE) implementation in hardware.

Prior approaches for memory monitoring have encountered various resource and configuration challenges. For example, some forms of rootkit detection have utilized virtualization and a guest environment to monitor virtual machine (VM) memory usage. Likewise, some types of memory controllers have been specially configured as a hardware RoT to scan and monitor memory. Likewise, security has been attempted within various CPU modes and instruction set architectures by locking down memory, cache, and stack elements that are expected to be read-only. These approaches require significant resources to design or operate and configure, and may not provide adequate re-configuration or verification capabilities.

The following techniques enable use of verified memory monitoring, as deployed and verified by an external verifier entity, within configurable hardware configurations of a computing system. With such techniques, a verifier installs a monitor on configurable hardware that is integrated into a target machine.

In an example, a cloud-based verifier may install a TMM, implemented with an FPGA configuration, onto FPGA hardware of an edge computing system, to configure the FPGA hardware to perform internal monitoring and processing of its DRAM status within the edge computing hardware. Further, this cloud-based verifier may be configured to also attest to the trustworthiness of the TMM (e.g., the FPGA configuration) that performs the local processing of the DRAM telemetry in a particular way.

In a further example, attestation is performed following the DICE industry standard for obtaining secure identities without secrets being compromised by firmware updates. Thus, the monitor is associated with a verifiable composite trust identifier binding it to the target platform into an unforgeable signature. A second verification step at the cloud-based verifier, based on the composite identifier, ensures that the monitor design has been installed at the FPGA in the target without it, or the target, being compromised

Flexibility and agility are supported with this configuration, due to the ability of the external verifier entity to install (and deploy from a remote location) a design onto the FPGA that contains expected, authorized, or known good memory images. Security of the trusted is improved, relative to prior approaches, because the resources used to implement the TMM are separate from CPU-based resources and are not shared by other CPU workloads. If the TMM becomes corrupted or compromised, a cloud verifier, orchestrator, or other entity may re-deploy a new TMM design rapidly. Finally, as will be well understood, the use of a dedicated FPGA design to contain and operate a TMM enables significant performance and maintainability over the use of alternative approaches.

The present techniques and configurations may be utilized in connection with many aspects of current networking systems, but are provided with reference to Edge Cloud, IoT, Multi-access Edge Computing (MEC), and other distributed computing deployments. The following systems and techniques may be implemented in, or augment, a variety of distributed, virtualized, or managed edge computing systems. These include environments in which network services are implemented or managed using multi-access edge computing (MEC) or 4G/5G wireless network configurations; or in wired network configurations involving fiber, copper, and other connections. However, the presently disclosed techniques may relate to other computing configurations and architectures, and are not limited to the use in a distributed computing environment.

Example Edge Computing Architectures

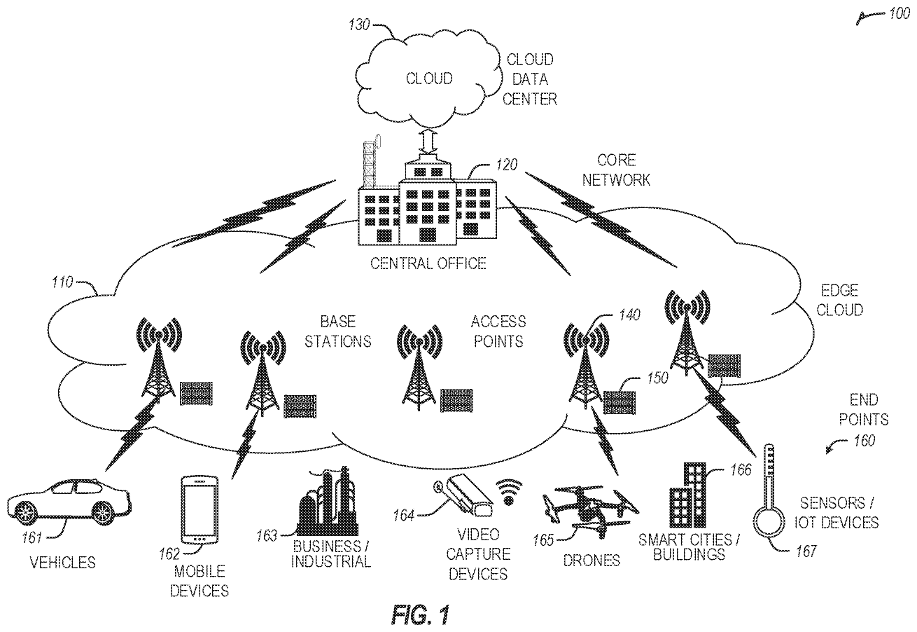

FIG. 1 is a block diagram 100 showing an overview of a configuration for edge computing, which includes a layer of processing referenced in many of the current examples as an “edge cloud”. This network topology, which may include a number of conventional networking layers (including those not shown herein), may be extended through use of the attestation techniques and network configurations discussed herein.

As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle. These and other scenarios may involve the use of attestation, as provided in the discussion below.

In contrast to the network architecture of FIG. 1, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud data-center.

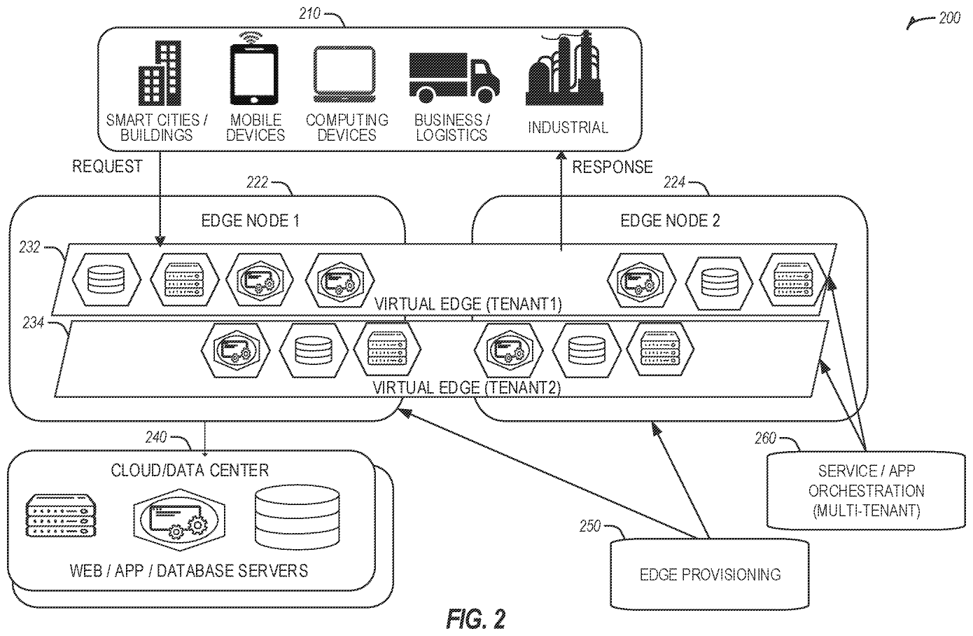

FIG. 2 illustrates deployment and orchestration for virtual edge configurations across an edge computing system operated among multiple edge nodes and multiple tenants. Specifically, FIG. 2 depicts coordination of a first edge node 222 and a second edge node 224 in an edge computing system 200, to fulfill requests and responses for various client endpoints 210 from various virtual edge instances. The virtual edge instances provide edge compute capabilities and processing in an edge cloud, with access to a cloud/data center 240 for higher-latency requests for websites, applications, database servers, etc. Thus, the edge cloud enables coordination of processing among multiple edge nodes for multiple tenants or entities.

In the example of FIG. 2, these virtual edge instances include: a first virtual edge 232, offered to a first tenant (Tenant 1), which offers a first combination of edge storage, computing, and services; and a second virtual edge 234, offering a second combination of edge storage, computing, and services, to a second tenant (Tenant 2). The virtual edge instances 232, 234 are distributed among the edge nodes 222, 224, and may include scenarios in which a request and response are fulfilled from the same or different edge nodes. The configuration of each edge node 222, 224 to operate in a distributed yet coordinated fashion occurs based on edge provisioning functions 250. The functionality of the edge nodes 222, 224 to provide coordinated operation for applications and services, among multiple tenants, occurs based on orchestration functions 260.

It should be understood that some of the devices in 210 are multi-tenant devices where Tenant1 may function within a Tenant 1 ‘slice’ while a Tenant2 may function within a Tenant2 slice. A trusted multi-tenant device may further contain a tenant specific cryptographic key such that the combination of key and slice may be considered a “root of trust” (RoT) or tenant-specific RoT. A RoT may further be computed dynamically composed using a security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The RoT also may be used for a trusted computing context to support respective tenant operations, etc. Use of this RoT and the security architecture may be enhanced by the attestation operations further discussed herein.

Edge computing nodes may partition resources (memory, CPU, GPU, interrupt controller, I/O controller, memory controller, bus controller, etc.) where each partition may contain a RoT capability and where fan-out and layering according to a DICE model may further be applied to edge nodes. Cloud computing nodes consisting of containers, FaaS (function as a service) engines, servlets, servers, or other computation abstraction may be partitioned according to a DICE layering and fan-out structure to support a RoT context for each. Accordingly, the respective RoTs spanning entities 210, 222, and 240 may coordinate the establishment of a distributed trusted computing base (DTCB) such that a tenant-specific virtual trusted secure channel linking all elements end-to-end can be established.

Additionally, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other security functions related to the provisioning and lifecycle of the trusted ‘slice’ concept in FIG. 2. An orchestrator may use a DICE layering and fan-out construction to create a root of trust context that is tenant-specific. Thus, orchestration functions, provided by an orchestrator, may participate as a tenant-specific orchestration provider.

Accordingly, an edge computing system may be configured to fulfill requests and responses for various client endpoints from multiple virtual edge instances (and, from a cloud or remote data center, not shown). The use of these virtual edge instances supports multiple tenants and multiple applications (e.g., AR/VR, enterprise applications, content delivery, gaming, compute offload) simultaneously. Further, there may be multiple types of applications within the virtual edge instances (e.g., normal applications, latency sensitive applications, latency critical applications, user plane applications, networking applications, etc.). The virtual edge instances may also be spanned across systems of multiple owners at different geographic locations.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to each tenant (aside the execution of virtualized network functions).

Within the edge cloud, a first edge node 222 (e.g., operated by a first owner) and a second edge node 224 (e.g., operated by a second owner) may operate or respond to a container orchestrator to coordinate the execution of various applications within the virtual edge instances offered for respective tenants. For instance, the edge nodes 222, 224 may be coordinated based on edge provisioning functions 250, while the operation of the various applications are coordinated with orchestration functions 260.

Various system arrangements may provide an architecture that treats VMs, Containers, and Functions equally in terms of application composition (and resulting applications are combinations of these three ingredients). Each ingredient may involve use of one or more accelerator (e.g., FPGA, ASIC) components as a local backend. In this manner, applications can be split across multiple edge owners, coordinated by an orchestrator.

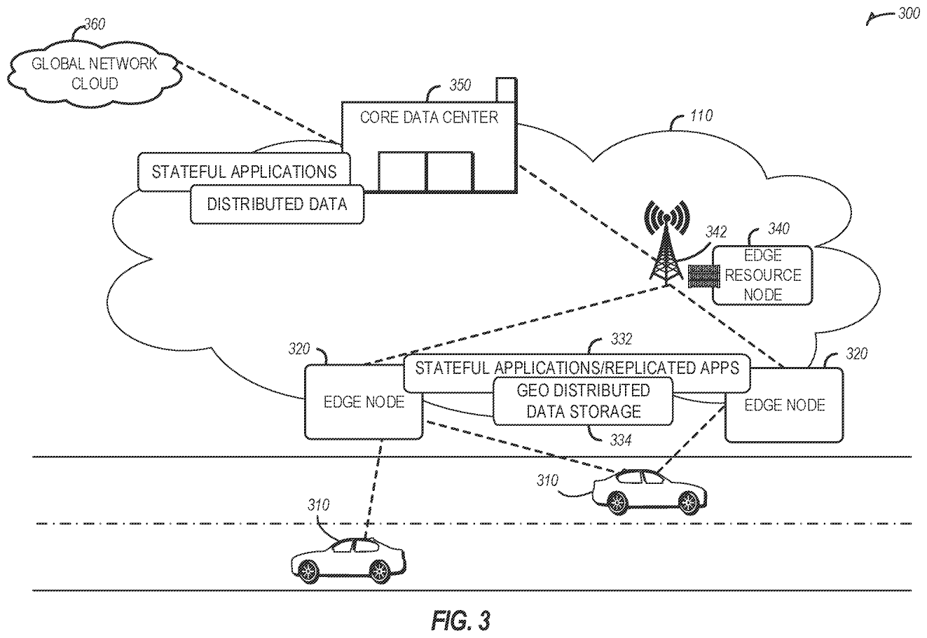

It should be appreciated that the edge computing systems and arrangements discussed herein may be applicable in various solutions, services, and/or use cases. As an example, FIG. 3 shows a simplified vehicle compute and communication use case involving mobile access to applications in an edge computing system 300 that implements an edge cloud 110. In this use case, each client compute node 310 may be embodied as in-vehicle compute systems (e.g., in-vehicle navigation and/or infotainment systems) located in corresponding vehicles that communicate with the edge gateway nodes 320 during traversal of a roadway. For instance, edge gateway nodes 320 may be located in a roadside cabinet or other enclosure built-into a structure having other, separate, mechanical utility, which may be placed along the roadway, at intersections of the roadway, or other locations near the roadway. As each vehicle traverses along the roadway, the connection between its client compute node 310 and a particular edge gateway node 320 may propagate so as to maintain a consistent connection and context for the client compute node 310. Each of the edge gateway nodes 320 includes some processing and storage capabilities and, as such, some processing and/or storage of data for the client compute nodes 310 may be performed on one or more of the edge gateway nodes 320.

Each of the edge gateway nodes 320 may communicate with one or more edge resource nodes 340, which are illustratively embodied as compute servers, appliances or components located at or in a communication base station 342 (e.g., a base station of a cellular network). As discussed above, each edge resource node 340 includes some processing and storage capabilities and, as such, some processing and/or storage of data for the client compute nodes 310 may be performed on the edge resource node 340. For example, the processing of data that is less urgent or important may be performed by the edge resource node 340, while the processing of data that is of a higher urgency or importance may be performed by edge gateway devices or the client nodes themselves (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 340 also communicate with the core data center 350, which may include compute servers, appliances, and/or other components located in a central location (e.g., a central office of a cellular communication network). The core data center 350 may provide a gateway to the global network cloud 360 (e.g., the Internet) for the edge cloud 110 operations formed by the edge resource node(s) 340 and the edge gateway nodes 320. Additionally, in some examples, the core data center 350 may include an amount of processing and storage capabilities and, as such, some processing and/or storage of data for the client compute devices may be performed on the core data center 350 (e.g., processing of low urgency or importance, or high complexity). The edge gateway nodes 320 or the edge resource nodes 340 may offer the use of stateful applications 332 and a geographic distributed data storage 334 (e.g., database, data store, etc.).

In further examples, FIG. 3 may utilize various types of mobile edge nodes, such as an edge node hosted in a vehicle (e.g., car, truck, tram, train, etc.) or other mobile unit, as the edge node may move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 320, some others at the edge resource node 340, and others in the core data center 350 or global network cloud 360.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including a support of respective functions that support edge computing as a service. Additional features of FaaS may include: a granular billing component that enables customers (e.g., computer code developers) to pay only when their code gets executed: common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

Example Internet of Things Architectures

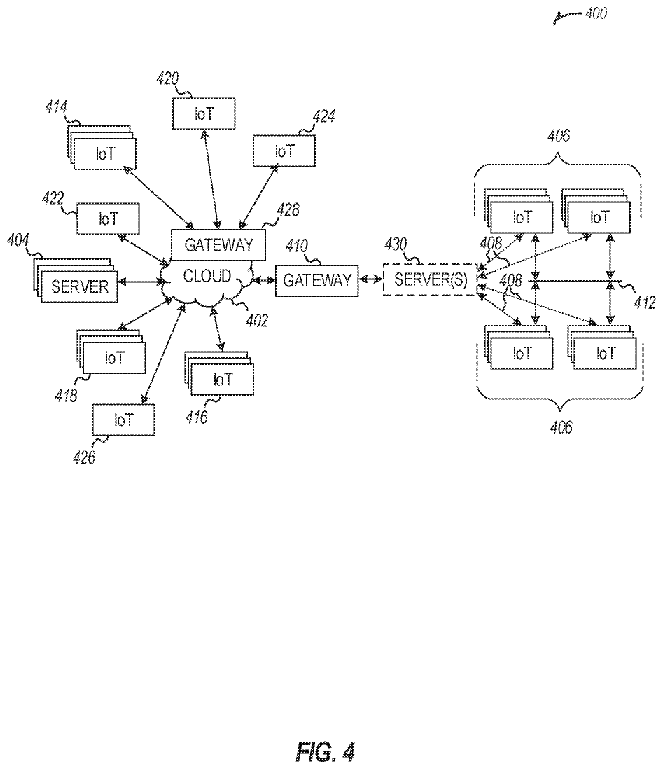

As a more detailed illustration of an Internet of Things (IoT) network, FIG. 4 illustrates a drawing of a cloud or edge computing network, referred to as “cloud” 400, in communication with a number of IoT devices. The IoT is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 4, the cloud 400 may represent the Internet, or may be a local area network (LAN), or a wide area network (WAN), such as a proprietary network for a company. The IoT devices may include any number of different types of devices, grouped in various combinations. For example, a traffic control group 406 may include IoT devices along streets in a city. These IoT devices may include stoplights, traffic flow monitors, cameras, weather sensors, and the like. The traffic control group 406, or other subgroups, may be in communication with the cloud 400 through wired or wireless links 408, such as LPWA links, optical links, and the like. Further, a wired or wireless sub-network 412 may allow the IoT devices to communicate with each other, such as through a local area network, a wireless local area network, and the like. The IoT devices may use another device, such as a gateway 410 or 428 to communicate with remote locations such as the cloud 400; the IoT devices may also use one or more servers 430 to facilitate communication with the cloud 400 or with the gateway 410. For example, the one or more servers 430 may operate as an intermediate network node to support a local edge cloud or fog implementation among a local area network. Further, the gateway 428 that is depicted may operate in a cloud-to-gateway-to-many edge devices configuration, such as with the various IoT devices 414, 420, 424 being constrained or dynamic to an assignment and use of resources in the cloud 400.

Other example groups of IoT devices may include remote weather stations 414, local information terminals 416, alarm systems 418, automated teller machines 420, alarm panels 422, or moving vehicles, such as emergency vehicles 424 or other vehicles 426, among many others. Each of these IoT devices may be in communication with other IoT devices, with servers 404, with another IoT device or system, another edge computing or “fog” computing system, or a combination therein. The groups of IoT devices may be deployed in various residential, commercial, and industrial settings (including in both private or public environments).

As may be seen from FIG. 4, a large number of IoT devices may be communicating through the cloud 400. This may allow different IoT devices to request or provide information to other devices autonomously. For example, a group of IoT devices (e.g., the traffic control group 406) may request a current weather forecast from a group of remote weather stations 414, which may provide the forecast without human intervention. Further, an emergency vehicle 424 may be alerted by an automated teller machine 420 that a burglary is in progress. As the emergency vehicle 424 proceeds towards the automated teller machine 420, it may access the traffic control group 406 to request clearance to the location, for example, by lights turning red to block cross traffic at an intersection in sufficient time for the emergency vehicle 424 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 414 or the traffic control group 406, may be equipped to communicate with other IoT devices as well as with the cloud 400. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide area (LPWA) network, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

An IoT network, arranged as a WLAN network, for instance, may use systems that perform standards conversion to provide multi-standard connectivity, enabling IoT devices using different protocols to communicate. Further systems may provide seamless interconnectivity across a multi-standard infrastructure comprising visible Internet resources and hidden Internet resources.

An IoT network, using communications in the cellular network, for instance, may be enhanced by systems that offload data, extend communications to more remote devices, or both. A LPWA network may include systems that perform non-Internet protocol (IP) to IP interconnections, addressing, and routing. Further, each of the IoT devices may include the appropriate transceiver for wide area communications with that device. Further, each IoT device may include other transceivers for communications using additional protocols and frequencies.

In further examples, an edge or cloud computing network may be in communication with a mesh network of IoT devices at the edge of the cloud computing network. The mesh network of IoT devices may be termed a fog device or system, operating at the edge of the cloud. This fog device or system may be a massively interconnected network where a number of IoT devices are in communications with each other by radio links, for example. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Example Computing Devices

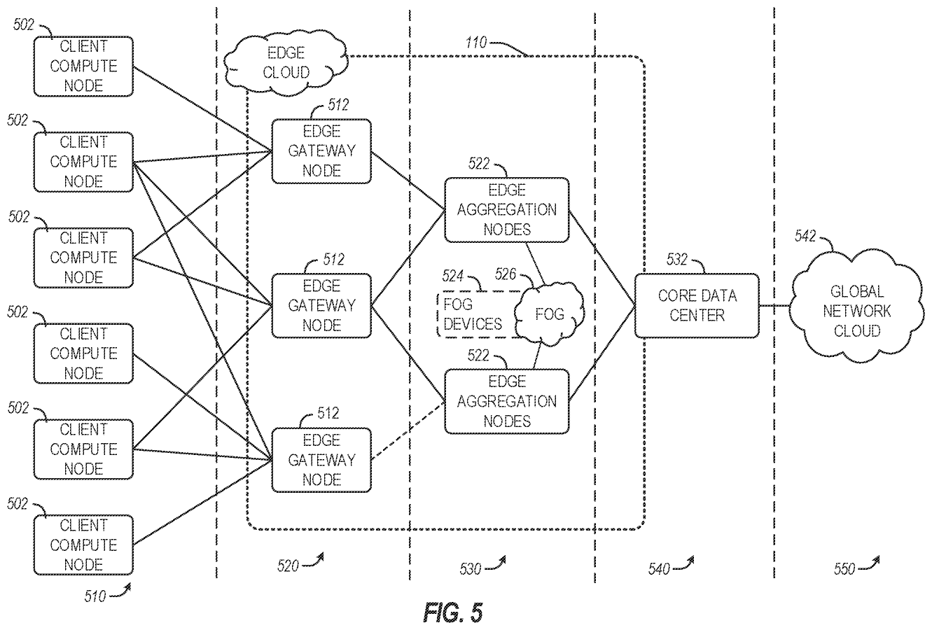

At a more generic level, an edge computing system may be described to encompass any number of deployments operating in the edge cloud 110, which provide coordination from client and distributed computing devices. FIG. 5 provides a further abstracted overview of layers of distributed compute deployed among an edge computing environment for purposes of illustration.

FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 620 (local level) of the edge computing system. Additionally, each of the edge aggregation nodes 522 (and/or fog devices 524, if arranged or operated with or among a fog networking configuration 526) are located at a network access layer 630 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 640 (e.g., a regional or geographically-central level), while the global network cloud 542 is located at a cloud data center layer 550 (e.g., a national or global layer). The use of “core” is provided as a term for a centralized network location-deeper in the network-which is accessible by multiple edge nodes or components; however, a “core” does not necessarily designate the “center” or the deepest location of the network. Accordingly, the core data center 532 may be located within, at, or near the edge cloud 110.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

Consistent with the examples provided herein, each client compute node 502 may be embodied as any type of end point component, device, appliance, or “thing” capable of communicating as a producer or consumer of data. Further, the label “node” or “device” as used in the edge computing system 500 does not necessarily mean that such node or device operates in a client or agent/minion/follower role; rather, any of the nodes or devices in the edge computing system 500 refer to individual entities, nodes, or subsystems which include discrete or connected hardware or software configurations to facilitate or use the edge cloud 110.

As such, the edge cloud 110 is formed from network components and functional features operated by and within the edge gateway nodes 512 and the edge aggregation nodes 522 of layers 520, 530, respectively. The edge cloud 110 may be embodied as any type of network that provides edge computing and/or storage resources which are proximately located to radio access network (RAN) capable endpoint devices (e.g., mobile computing devices. IoT devices, smart devices, etc.), which are shown in FIG. 5 as the client compute nodes 502. In other words, the edge cloud 110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 110 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 110 between the core data center layer 550 and the client endpoints (e.g., client compute nodes 502). Some of these are discussed in the following sections in the context of network functions or service virtualization, including the use of virtual edges and virtual services which are orchestrated for multiple stakeholders.

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

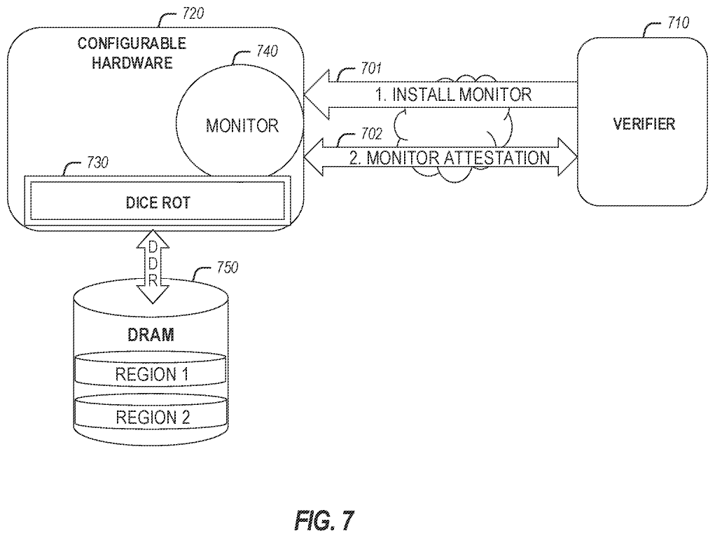

In various examples, the present memory monitoring techniques may be implemented among the client compute nodes 502 (e.g., at a client who receives an attestation token), at the edge gateway nodes 512 or aggregation nodes 522 (e.g., at a resource node which has a resource to be attested), and other intermediate nodes in the edge cloud 110 (e.g., which operate orchestrator functions, attestation service functions, etc.), as further discussed below with reference to the various configurations provided in FIGS. 7 to 11. Additionally, while reference to a “cloud verifier” is provided in many of the following examples, the verifier may also be located at various levels of the network 520, 530, 540.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 may be formed from network components and functional features operated by and within edge gateway nodes, edge aggregation nodes, or other edge compute nodes among various network layers. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

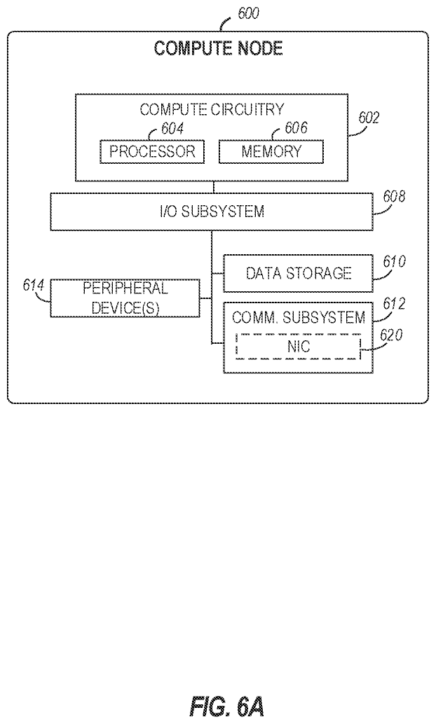

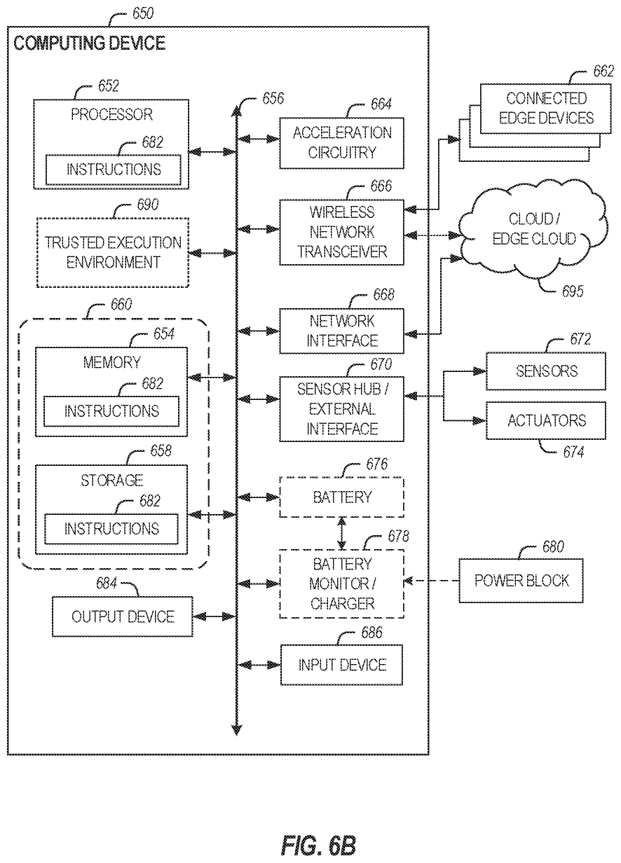

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 6B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

In further examples, any of the compute nodes or devices discussed with reference to the present edge computing systems and environment may be fulfilled based on the components depicted in FIGS. 6A and 6B. Each edge compute node may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 6A, an edge compute node 600 includes a compute engine (also referred to herein as “compute circuitry”) 602, an input/output (I/O) subsystem 608, data storage 610, a communication circuitry subsystem 612, and, optionally, one or more peripheral devices 614. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 600 may be embodied as any type of engine, device, or collection of devices capable of performing various compute functions. In some examples, the compute node 600 may be embodied as a single device such as an integrated circuit, an embedded system, a field-programmable gate array (FPGA), a system-on-a-chip (SOC), or other integrated system or device. In the illustrative example, the compute node 600 includes or is embodied as a processor 604 and a memory 606. The processor 604 may be embodied as any type of processor capable of performing the functions described herein (e.g., executing an application). For example, the processor 604 may be embodied as a multi-core processor(s), a microcontroller, or other processor or processing/controlling circuit. In some examples, the processor 604 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 604 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 604 may work in coordination with each other to execute many types of operations and instructions within and on behalf of the compute node 600.

The main memory 606 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 606 may be integrated into the processor 604. The main memory 606 may store various software and data used during operation such as one or more applications, data operated on by the application(s), libraries, and drivers.

The compute circuitry 602 is communicatively coupled to other components of the compute node 600 via the I/O subsystem 608, which may be embodied as circuitry and/or components to facilitate input/output operations with the compute circuitry 602 (e.g., with the processor 604 and/or the main memory 606) and other components of the compute circuitry 602. For example, the I/O subsystem 608 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 608 may form a portion of a system-on-a-chip (SoC) and be incorporated, along with one or more of the processor 604, the main memory 606, and other components of the compute circuitry 602, into the compute circuitry 602.

The one or more illustrative data storage devices 610 may be embodied as any type of devices configured for short-term or long-term storage of data such as, for example, memory devices and circuits, memory cards, hard disk drives, solid-state drives, or other data storage devices. Each data storage device 610 may include a system partition that stores data and firmware code for the data storage device 610. Each data storage device 610 may also include one or more operating system partitions that store data files and executables for operating systems depending on, for example, the type of compute node 600.

The communication circuitry 612 may be embodied as any communication circuit, device, or collection thereof, capable of enabling communications over a network between the compute circuitry 602 and another compute device (e.g., an edge gateway node 512 of the edge computing system 500). The communication circuitry 612 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The illustrative communication circuitry 612 includes a network interface controller (NIC) 620, which may also be referred to as a host fabric interface (HFI). The NIC 620 may be embodied as one or more add-in-boards, daughter cards, network interface cards, controller chips, chipsets, or other devices that may be used by the compute node 600 to connect with another compute device (e.g., an edge gateway node 512). In some examples, the NIC 620 may be embodied as part of a system-on-a-chip (SoC) that includes one or more processors, or included on a multichip package that also contains one or more processors. In some examples, the NIC 620 may include a local processor (not shown) and/or a local memory (not shown) that are both local to the NIC 620. In such examples, the local processor of the NIC 620 may be capable of performing one or more of the functions of the compute circuitry 602 described herein. Additionally or alternatively, in such examples, the local memory of the NIC 620 may be integrated into one or more components of the client compute node at the board level, socket level, chip level, and/or other levels.

Additionally, in some examples, each compute node 600 may include one or more peripheral devices 614. Such peripheral devices 614 may include any type of peripheral device found in a compute device or server such as audio input devices, a display, other input/output devices, interface devices, and/or other peripheral devices, depending on the particular type of the compute node 600. In further examples, the compute node 600 may be embodied by a respective edge compute node in an edge computing system (e.g., client compute node 502, edge gateway node 512, edge aggregation node 522) or like forms of appliances, computers, subsystems, circuitry, or other components.

In a more detailed example, FIG. 6B illustrates a block diagram of an example of components that may be present in an edge computing node 650 for implementing the techniques (e.g., operations, processes, methods, and methodologies) described herein. The edge computing node 650 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 650, or as components otherwise incorporated within a chassis of a larger system.

The edge computing node 650 may include processing circuitry in the form of a processor 652, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 652 may be a part of a system on a chip (SoC) in which the processor 652 and other components are formed into a single integrated circuit, or a single package, such as the Edison™ or Galileo™ SoC boards from Intel Corporation, Santa Clara, Calif. As an example, the processor 652 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 652 and accompanying circuitry may be provided in a single socket form factor, multiple socket form factor, or a variety of other formats, including in limited hardware configurations or configurations that include fewer than all elements shown in FIG. 6B.

The processor 652 may communicate with a system memory 654 over an interconnect 656 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules. e.g., dual inline memory modules (DIMMs) of different varieties including but not limited to microDIMMs or MiniDIMMs.

To provide for persistent storage of information such as data, applications, operating systems and so forth, a storage 658 may also couple to the processor 652 via the interconnect 656. In an example, the storage 658 may be implemented via a solid-state disk drive (SSDD). Other devices that may be used for the storage 658 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 658 may be on-die memory or registers associated with the processor 652. However, in some examples, the storage 658 may be implemented using a micro hard disk drive (HDD). Further, any number of new technologies may be used for the storage 658 in addition to, or instead of, the technologies described, such resistance change memories, phase change memories, holographic memories, or chemical memories, among others.

The components may communicate over the interconnect 656. The interconnect 656 may include any number of technologies, including industry standard architecture (ISA), extended ISA (EISA), peripheral component interconnect (PCI), peripheral component interconnect extended (PCIx), PCI express (PCIe), or any number of other technologies. The interconnect 656 may be a proprietary bus, for example, used in an SoC based system. Other bus systems may be included, such as an I2C interface, an SPI interface, point to point interfaces, and a power bus, among others.

The interconnect 656 may couple the processor 652 to a transceiver 666, for communications with the connected edge devices 662. The transceiver 666 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 662. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 666 (or multiple transceivers) may communicate using multiple standards or radios for communications at a different range. For example, the edge computing node 650 may communicate with close devices, e.g., within about 10 meters, using a local transceiver based on BLE, or another low power radio, to save power. More distant connected edge devices 662, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 666 (e.g., a radio transceiver) may be included to communicate with devices or services in the edge cloud 695 via local or wide area network protocols. The wireless network transceiver 666 may be an LPWA transceiver that follows the IEEE 802.15.4, or IEEE 802.15.4g standards, among others. The edge computing node 650 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 666, as described herein. For example, the transceiver 666 may include a cellular transceiver that uses spread spectrum (SPA/SAS) communications for implementing high-speed communications. Further, any number of other protocols may be used, such as Wi-Fi® networks for medium speed communications and provision of network communications. The transceiver 666 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 668 may be included to provide a wired communication to nodes of the edge cloud 695 or to other devices, such as the connected edge devices 662 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 668 may be included to enable connecting to a second network, for example, a first NIC 668 providing communications to the cloud over Ethernet, and a second NIC 668 providing communications to other devices over another type of network.

Given the variety of types of applicable communications from the device to another component or network, applicable communications circuitry used by the device may include or be embodied by any one or more of components 664, 666, 668, or 670. Accordingly, in various examples, applicable means for communicating (e.g., receiving, transmitting, etc.) may be embodied by such communications circuitry.

The edge computing node 650 may include or be coupled to acceleration circuitry 664, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 656 may couple the processor 652 to a sensor hub or external interface 670 that is used to connect additional devices or subsystems. The devices may include sensors 672, such as accelerometers, level sensors, flow sensors, optical light sensors, camera sensors, temperature sensors, a global positioning system (GPS) sensors, pressure sensors, barometric pressure sensors, and the like. The hub or interface 670 further may be used to connect the edge computing node 650 to actuators 674, such as power switches, valve actuators, an audible sound generator, a visual warning device, and the like.

In some optional examples, various input/output (I/O) devices may be present within or connected to, the edge computing node 650. For example, a display or other output device 684 may be included to show information, such as sensor readings or actuator position. An input device 686, such as a touch screen or keypad may be included to accept input. An output device 684 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 650. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 676 may power the edge computing node 650, although, in examples in which the edge computing node 650 is mounted in a fixed location, it may have a power supply coupled to an electrical grid. The battery 676 may be a lithium ion battery, or a metal-air battery, such as a zinc-air battery, an aluminum-air battery, a lithium-air battery, and the like.

A battery monitor/charger 678 may be included in the edge computing node 650 to track the state of charge (SoCh) of the battery 676. The battery monitor/charger 678 may be used to monitor other parameters of the battery 676 to provide failure predictions, such as the state of health (SoH) and the state of function (SoF) of the battery 676. The battery monitor/charger 678 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 678 may communicate the information on the battery 676 to the processor 652 over the interconnect 656. The battery monitor/charger 678 may also include an analog-to-digital (ADC) converter that enables the processor 652 to directly monitor the voltage of the battery 676 or the current flow from the battery 676. The battery parameters may be used to determine actions that the edge computing node 650 may perform, such as transmission frequency, mesh network operation, sensing frequency, and the like.

A power block 680, or other power supply coupled to a grid, may be coupled with the battery monitor/charger 678 to charge the battery 676. In some examples, the power block 680 may be replaced with a wireless power receiver to obtain the power wirelessly, for example, through a loop antenna in the edge computing node 650. A wireless battery charging circuit, such as an LTC4020 chip from Linear Technologies of Milpitas, Calif., among others, may be included in the battery monitor/charger 678. The specific charging circuits may be selected based on the size of the battery 676, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 658 may include instructions 682 in the form of software, firmware, or hardware commands to implement the techniques described herein. Although such instructions 682 are shown as code blocks included in the memory 654 and the storage 658, it may be understood that any of the code blocks may be replaced with hardwired circuits, for example, built into an application specific integrated circuit (ASIC).

In an example, the instructions 682 provided via the memory 654, the storage 658, or the processor 652 may be embodied as a non-transitory, machine-readable medium 660 including code to direct the processor 652 to perform electronic operations in the edge computing node 650. The processor 652 may access the non-transitory, machine-readable medium 660 over the interconnect 656. For instance, the non-transitory, machine-readable medium 660 may be embodied by devices described for the storage 658 or may include specific storage units such as optical disks, flash drives, or any number of other hardware devices. The non-transitory, machine-readable medium 660 may include instructions to direct the processor 652 to perform a specific sequence or flow of actions, for example, as described with respect to the flowchart(s) and block diagram(s) of operations and functionality depicted above. As used in, the terms “machine-readable medium” and “computer-readable medium” are interchangeable.

Also in a specific example, the instructions 682 on the processor 652 (separately, or in combination with the instructions 682 of the machine readable medium 660) may configure execution or operation of a trusted execution environment (TEE) 690. In an example, the TEE 690 operates as a protected area accessible to the processor 652 for secure execution of instructions and secure access to data. Various implementations of the TEE 690, and an accompanying secure area in the processor 652 or the memory 654 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 650 through the TEE 690 and the processor 652.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 6A and 6B are intended to depict a high-level view of components of a device, subsystem, or arrangement of an edge computing node. However, it will be understood that some of the components shown may be omitted, additional components may be present, and a different arrangement of the components shown may occur in other implementations.

Memory Management Examples

The following sections provide an implementation example, designed to ensure that DRAM contents at certain defined points in time match expected values (or their measurements) as expected, and to monitor the sensitive regions of DRAM for detection of improper changes in a timely way. Additionally, the following describes an augmentation which enables the robust surveillance over DRAM contents to continue to apply beyond such defined points. Finally, examples are provided illustrating mechanisms that harden the memory monitoring mechanism so that it continues to be effective during transients when the verifier is disconnected from the monitor.

In the context of a deployed system (such as the edge computing system(s) depicted in FIG. 5) the present techniques and configurations provide the capability for monitoring and verification of a memory status at an individual edge computing node. In light of a larger computing system context, FIG. 7 illustrates a block diagram depicting an overview of a computing system architecture, supporting memory management operations. FIG. 7 is simplified to show the essential elements of operation between a verifier entity 710 (e.g., cloud verifier), configurable hardware 720 (e.g., ASIC/FPGA), hardware-based RoT 730 (e.g., DICE RoT), and monitored memory 750 (e.g., DRAM). Although discussed as a cloud service, the verifier entity 710 may be any orchestrator, gateway, or coordinator (e.g., in an IoT edge device deployment, which is often an isolated network).

Thus, within FIG. 7, the verifier entity 710 establishes operations based on an implementation of a DICE security architecture, to install the monitor (e.g., a TMM, installed with operation 701) to the configurable hardware 720 in response to satisfactory authentication and attestation of the configurable hardware 720 (e.g., as provided by the DICE RoT 730). The monitor 740 is used to perform monitoring of the various regions of DRAM 750 connected to the configurable hardware device. The verifier 710 may perform ongoing monitoring of attestation and verification of secure operations at the configurable hardware 720 (e.g., with operation 702). Specifically, the contents of specified DRAM regions (shown as Regions 1 and 2 in FIG. 7) are checked against their expected values by the monitor's execution. The regions of DRAM 750 to be monitored and the expected contents are provided to the monitor 740 by the verifier 710.

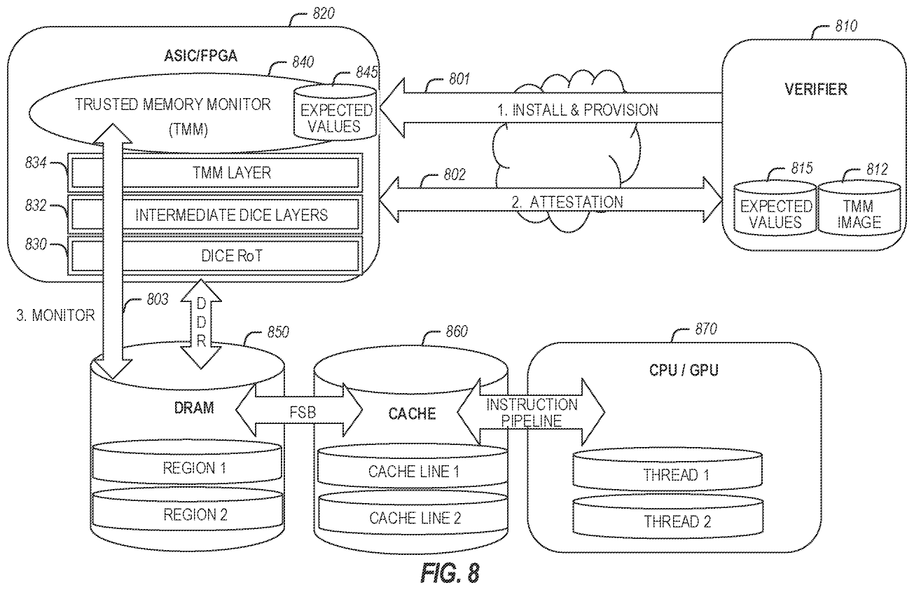

FIG. 8 illustrates a block diagram depicting an overview of a computing system architecture, supporting memory management operations from a verified trusted memory monitor 840. Similar to the architecture introduced in FIG. 7, the architecture of FIG. 8 depicts the use of a verifier 810, performing operations 801, 802 to install and provision the trusted memory monitor 840 (e.g., from TMM image 812), and ongoing attestation (e.g., between expected values 815, 845). The attestation operations 802 may validate additional elements of the computing architecture (e.g., Cache 860, threads of the CPU/GPU 870) and security verification layers (e.g., TMM layer 834, intermediate DICE layers 832, and the DICE RoT 830), as illustrated.

In an example, the multiple security verification layers may be coordinated according to a DICE specification which provides security among multiple hardware and software layers. Further, it will be understood that the other operational elements of the monitored hardware architecture (e.g., the cache lines included in a cache 860, which are connected to a DRAM memory 850 via a front-side bus (FSB), and the threads of a CPU/GPU 870, which utilize instruction pipelines on the cache 860), are able to be monitored and verified (e.g., with operation 803) as a result of the operations monitored in the DRAM memory 850.

Within the DRAM memory 850 there may be some type of partitioning of the memory, which may be based on a use case context, such as tenancy, isolation, etc. The memory hierarchy, accessible through the DRAM memory 850, the Cache 860, and the CPU/GPU 870, and the execution and instruction pipeline that relates those pieces together, may be verified through monitoring memory via a deployed and attested TMM instance 840 operated in the configurable hardware, as depicted with an ASIC/FPGA 820.

Although not depicted, additional processing units may be utilized in this architecture, such as xPUs, NPUs (network processing units), IPUs (infrastructure processing units), memory, IO, security, and sensor micro controllers, FPGAs programmed to execute xPU instructions, and domain isolated modes of a CPU/GPU. Each processing unit may have a different RoT, and a secure interaction that is established and attested between the memory controller RoT and the respective processing unit RoT. Thus, a variety of instruction pipelines, cache lines, and communication channels may be established between hardware elements that are verified and monitored.

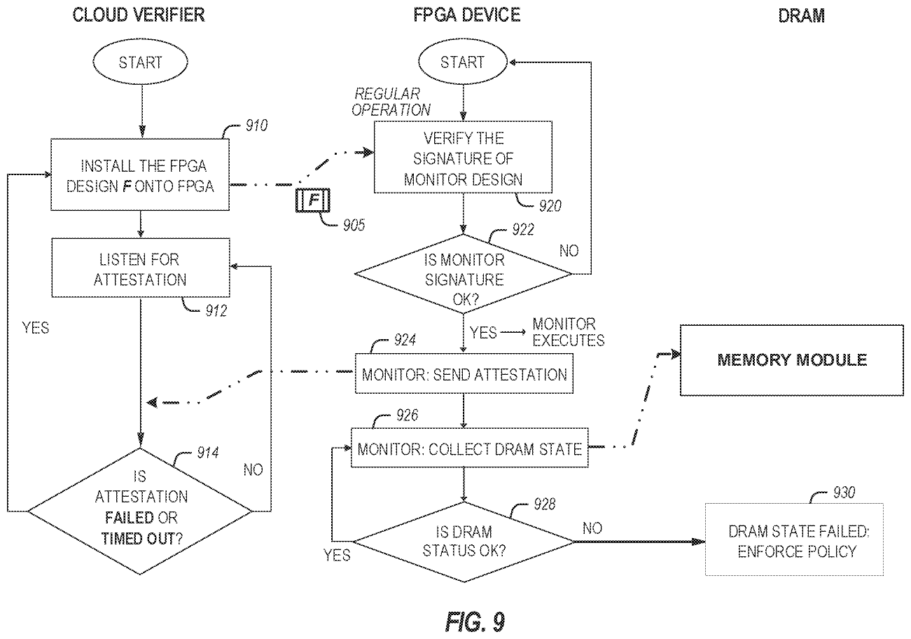

FIG. 9 illustrates a flow of an example process for attesting and verifying a monitoring component used for monitoring memory status, using the configuration of FIG. 8. Specifically, this process enables integrity monitoring of edge node execution, based on the memory state of the edge node, using a Monitor implemented by an FPGA (e.g., monitors 740, 840).

In an example, the cloud verifier installs the monitor (e.g., by deploying an FPGA design 905) onto the FPGA device (operation 910), and the FPGA device verifies the Monitor (e.g., with verification of a digital signature, in operation 920). If the verification succeeds (e.g., the signature is ok, in evaluation 922), the FPGA device executes the Monitor, which sends the attestation information to the cloud verifier (e.g., with operation 924); the FPGA device then continues monitoring operations by checking the DRAM state with the Monitor. If the DRAM state (e.g., regions 1 and/or 2) is corrupt (e.g., collected with operation 926, and identified in evaluation 928), a policy enforcement is triggered (operation 930). Meanwhile, the cloud verifier listens for attestation information (e.g., in operation 912), verifies the attestation information sent by the FPGA device (e.g., with evaluation 914), and upon failure, reinstalls the monitor onto the FPGA device. Should it happen that the target platform or FPGA in it is restarted (e.g., as a result of a restart), the installed design will again be reverified, or a new design installed.

In an example, the message to apply design 905 may contain a policy for matching memory images that are expected to be or known as good, or otherwise considered to be the reference template or trained template that performs the function of operation 920. Also, operation 910 may obtain reference values (otherwise known as manifests, platform certificates, signed documents, endorsements or attestation tokens) from various manufacturers or vendors of discrete logic, firmware, or software for workloads under inspection, at operation 926 and according to the techniques above.

The configuration of FIG. 9 supports autonomous isolated operation (offline operation) following an on-line installation and provisioning phase. Specifically, such isolated operation may include comparison of the expected values (for DRAM state) against monitored values that are supplied to the TMM in the FPGA from a Cloud/Edge orchestration/management entity. Offline operation then begins when a tenant workload is loaded into a memory region (e.g., DRAM) and the TMM is memory mapped to the various region pages.

Updates to memory pages (e.g., locked down pages) may be detected by the TMM by observing changes to page table entries and memory checksums. The memory controller used in the system architecture may assist this detection by notifying the TMM when such changes are applied. In such a scenario, the TMM and memory controller are presumed to have established a trust relationship (e.g., a trust relationship established using bi-lateral DICE attestation/verification exchange a priori). Further, another assumption is that the system architecture supports memory region isolation through the cache lines and through the threading systems (through the threading models), such as with use of Intel MKTME, SGX, virtualization, and like cryptography isolation.

The TMM may be likewise monitored by the verifier or another Cloud/Edge orchestrator/manageability node by receiving periodic attested health updates from the TMM. This ensures that the cloud verifier can detect possible attacks to the TMM. In an example, only suspicious behavior is relayed back to the cloud verifier as part of the health check status, whereas normal operations result in a heartbeat message.

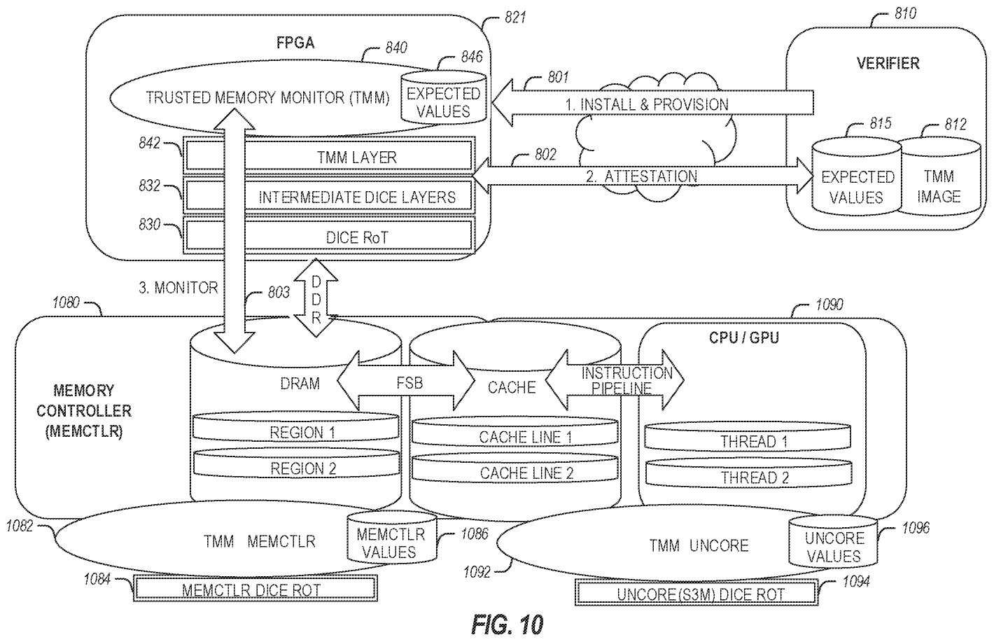

FIG. 10 illustrates a block diagram depicting an overview of a further configured computing system architecture, supporting memory management operations with a memory controller 1080. Similar to the previous configurations illustrated with reference to FIGS. 8 and 9, FIG. 10 also includes the deployment of a TMM 840 at configurable hardware (e.g., via an FPGA 821) from a verifier 810 (e.g., a cloud verifier, although any entity which is remote or external, accessed over a network or system bus, may provide verifier operations).

As discussed with reference to the previous configurations, the TMM layer 842 implements the TMM operations, and the verification of the TMM layer 842 is performed using expected TMM values with attestation 802 (e.g., as discussed above). Thus, the DRAM can be continuously monitored using the TMM 840 operated by the configurable ASIC/FPGA hardware 821 as discussed above.

However, FIG. 10 further illustrates the involvement and role of a TMM programming being provided to a connected memory controller 1080 and an uncore 1090 (the uncore referring to a controller, “system agent”, or other host of functions of the CPU/processing unit that are not within the processor core but closely connected or coordinated with the core). In this fashion, the memory controller 1080 may perform TMM monitoring and verification functions of memory locations, in coordination with the configurable FPGA 821, and the uncore 1090 may perform TMM monitoring and verification functions for cache or CPU locations (e.g., with TMMs 1082, 1092), such as to verify cache lines, threads, etc. for specific operations, instructions, and data within lower processing levels.

The memory controller 1080 and the uncore 1090 may have an associated DICE RoT (e.g., with memory controller RoT 1084, and with S3M 1094, a DICE RoT at the CPU) which enables trusted software operations to be attested and performed. Such trusted software operations may occur from the distribution of a TMM image 812 and TMM values 1086, 1096, coordinated from the FPGA to the memory controller 1080 or the uncore 1090. Thus, in the same fashion that the external verifier deploys trusted monitoring operations and configurations to the TMM 840 at the FPGA 821, the FPGA 821 may deploy trusted monitoring operations and configurations to the memory controller 1080 and the uncore 1090.

In this fashion, a detailed memory management hierarchy may be launched at multiple levels of a computing system, allowing many types of configurable hardware components (an ASIC/FPGA, memory controller, an uncore) to assist with monitoring operations. Other designs in which the ASIC/FPGA serves as a gatekeeper to verify security operations from an edge, IoT, or cloud computing orchestrator may also be implemented.

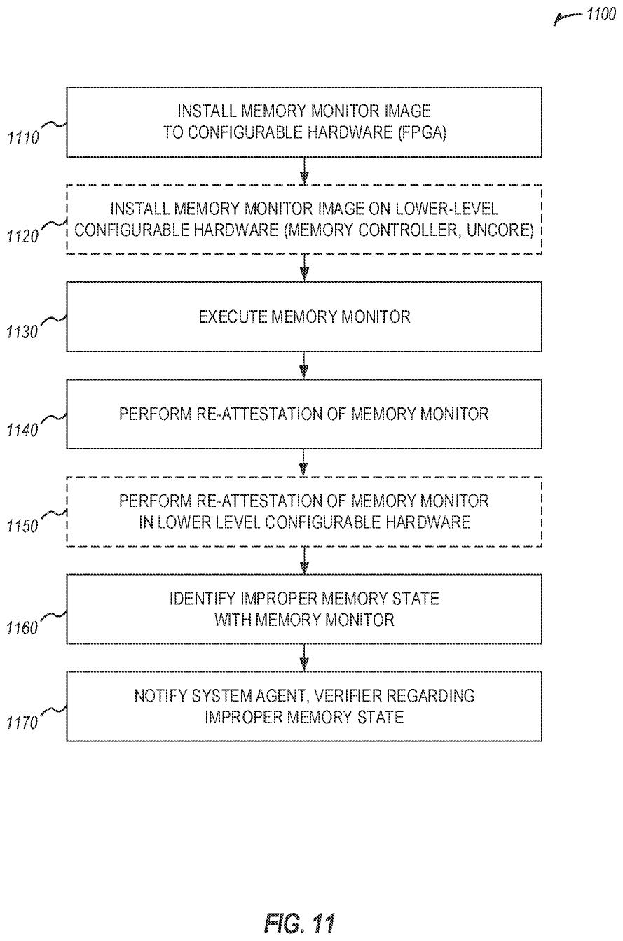

FIG. 11 illustrates a flowchart 1100 of an example method for deploying a trusted memory monitor and monitoring memory status with the trusted memory monitor. This flowchart 1100 is adapted to follow the operations identified above with reference to FIG. 9, and the configurations deployed among FIGS. 7, 8, and 10.

At 1110, a memory monitor image is installed to configurable hardware (e.g., an FPGA), such as is provided by a TMM configuration image from an external verifier. At 1120, an optional step of installing the memory monitor image on lower level configurable hardware may be performed, such as to coordinate installation of a TMM image on a memory controller, system agent (uncore), etc.

At 1130, the memory monitor (or multiple monitors) is executed; at 1140, re-attestation of this memory monitor is performed to verify an integrity state of the monitor. If additional memory monitors are operational at lower levels of hardware, then at 1150 these monitors may be re-attested.

At 1160, the memory monitor operates to identify an improper memory state (e.g., of one or more memory pages in DRAM). At 1170, an entity (e.g., a system agent, an external verifier, etc.) is notified regarding the improper memory state.

Although described with reference to an FPGA and memory components, it will be understood that the present techniques may be expanded to a variety of other hardware deployments. Further, as IP blocks become plug and play, memory controllers and other hardware entities can be attestable, and can be supported with a distributed root of trust, based on singleton roots of trust.

Comprehensive Shielding for Updates to Monitored Contents

The techniques and architecture discussed above may be used to easily detect memory corruption, at least for those regions of memory that are either known to be read-only, or where the updates are trapped first by page table protection. In the following sections, the techniques and architecture discussed above are extended with incremental hardware and software capabilities to achieve efficiency and timeliness in detection and verification of updates, so that corrupt updates or corrupting overwrites can be isolated quickly, and, without penalizing performance.

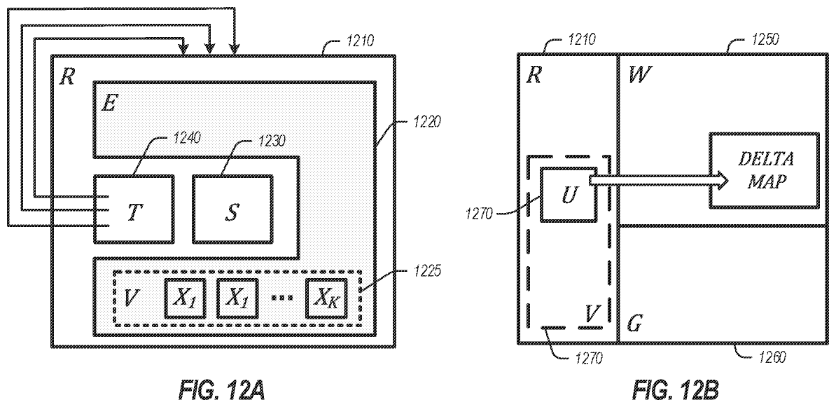

FIG. 12A illustrates an example of a memory architecture. Within FIG. 12A, a portion of memory, a root region 1210, is designated as R. This region R 1210 is monitored as described above. The region R 1210 is further comprised of mostly immutable, pre-determined contents; its non-immutable contents are rarely updated, and when updated, are updated in a controlled manner that transitions them from known expected initial state to a known expected final state in each such update using static capabilities built-into R. As a result, region R 1210 is easily and efficiently monitored simply by measuring and comparing its contents with expected measurements.

Region R includes several subranges E 1220, S 1230, and T 1240 as shown in FIG. 12A. The subrange E 1220 includes another subrange V 1225, and subrange V 1225 in turn includes a number of “extension mechanism” subranges shown as X₁, X₂, . . . X_{K}. Below is a description of each of these components, followed by a function that the root region R 1210 delivers using this construction.

1) T 1240 contains page translation tables that map virtual addresses employed in R 1210, to pages that are pinned and belong to R 1210. Thus, not only is R 1210 immutable (or largely immutable), but its translation resources T 1240, contained within itself, are unchanging.

2) E 1220 contains an immutable runtime, typically including a platform supervisory runtime such as an operating system, a hypervisor, a hypervisor with various tools and utilities, a hypervisor together with images for various common guest kernels, etc.

3) S 1230 contains the runtime's state S 1230 (including any metadata or data structures that facilitate access to the state) that are either immutable or when not immutable, may only be updated through wrapped (e.g., “set( . . . , . . . )”) operations—sometimes referred to as object interfaces, and these set operations are contained as immutable operations in E 1220. Each set operation may update an expected hash-code over S 1230, so that an out-of-band corruption in S 1230 produced by an attacker is detectable by the TMM. The runtime state S 1230 includes signatures of various other components that are subsequently added to the platform, including any updates or extensions to E 1220.

4) The subrange V 1225 contains several extending software mechanisms, comprising various libraries, tools, utilities, etc., through which the efficient surveillance over R 1210 is extended to other DIMM ranges. Interfaces for installing these mechanisms in a controlled manner are also integrated into V 1225. In FIG. 12A, these extending mechanisms are shown as subranges X₁, X₂, . . . X_{K}. The role of these mechanisms is described shortly in the following subsections, which discuss TMM-based stability of the root region, and efficient monitoring of non-root regions.

TMM-based stability of Root Region—As a result of this construction, where the monitoring and verification by the FPGA of root region R 1210 creates an unassailable memory image for an execution environment which consists of an evolvable yet mechanically verifiable OS/runtime; and any secure libraries, utilities etc. that may be added to the OS/runtime as components V 1225, and stitched securely (e.g., non-forgeably) through signatures in S 1230 provided by the cloud-verifier. This construction delivers immediate benefits. First, the region R 1210, when hosted in persistent memory, can be verified at one time, and then, because it is self-contained with respect to its own page tables, and is immutable, is self-certifying when in a disconnected operation; particularly where the disconnected operation occurs as a result of a restart during which a machine has no connectivity to a cloud verifier. Then, when the machine is back online, and its FPGA-based monitor is reverified and re-attested, and the memory monitoring process can resume. Second, the library V 1225 is itself immutable by virtue of being anchored in R 1210. Third, R 1210 being immutable, all libraries/tools/utilities and their associated state and signatures, are also verified by extension from a self-certifying R 1210; further, E 1220 (including components installed in V 1225) also validate cleanly initialized platform memory soon after a machine restart so that trojans cannot be inserted into system memory during the process of a machine restart. This also enables an efficient method of protecting the non-root region memory ranges.

Efficient monitoring of non-root regions. As shown in FIG. 12B, additional nonroot regions of memory (outside of root region R 1210) may be provided. In an example, the nonroot space of applications is divided into two groups: the first is a group W 1250 of applications (e.g., on a trusted list) that are amenable to being modified in a standard way (by a compiler or binary editor inserting the modifications), and a second group G 1260 (e.g., not in the trusted list) that is not similarly amenable. For the amenable (first) group W 1250, a compiler or binary translator/binary editor based modification of store instructions causes each store to be reflected into a compact “delta-map” which is basically a searchable set of tuples that reflects for each modified datum (quantum of which can be a quad-word, a cache line, etc.) its location and an XOR between its current value and its previous value. An extensible yet compact hash such as a cuckoo hash can serve as a data structure for this delta-map. The compiler or library utilities and/or retranslated versions of software may be placed as an extension U 1280 in the subrange R.V 1270 as shown in FIG. 12B.

In an further example, a FPGA-based TMM may be expanded to: (a) scan modified pages by traversing the compact hash, and compute two checksums per page: B (before) and A (after), where the checksum B is the checksum a page before the updates in a given scan interval, and the checksum A is the checksum of the same page with its current value. The TMM verifies that (1) the B checksum matches the current recorded checksum (in the expected values table); and (2) that the new values for the page's modified locations match their new values in the compact hash, and (3) reclaims the hash location (with a bitmap) and (4) updates the recorded checksum to A for future verification. In this way, the monitoring is driven from a compact range which is also reclaimed and recycled continuously. The tools (utilities) that insert the above deduplications into the amended applications are hosted in V 1270, and also hosted in V 1270 are the signatures computed over the amended applications, so that the applications themselves may be scanned (for signature regeneration) to compare with their known good signatures.

Additionally, a lightweight strategy may be provided for the second group, G 1260. Such applications may be divided into separate memory pools (containers, VMs, etc.) so that physical pages assigned to one pool do not get shared with another pool. Any corruption of memory that is read-only in these applications can be performed efficiently through check-summing and verification of the read-only portions of the applications. Writes to non-read only pages in each pool are filtered through page table entry monitoring, and are logged; and these can then be verified by the TMM-FPGA memory monitoring implementation, at the normal overhead. Compared to the first group of self-deduplicating applications (where the writes get captured without the cost of a trap), in this group, the writes trap each time. A verifier may therefore prescribe a policy that excludes non-essential pages or non-sensitive applications from write monitoring. Another option to reduce vulnerability to malicious tampering is to migrate pages (same virtual, different physical) on a random basis so that a concerted attack against a given application can be blunted when the attack is from outside the application.

Self-Verifying FPGA Implementation Bootstrapped from a Cloud

In still further examples, hardening enhancements may be adapted on the monitoring designs discussed above with reference to FIGS. 7 to 9.

Hardening 1: In an example, a two part FPGA design may be provided, denoted by F1 and F2. This design includes the following:

1) F1 contains the design F depicted in FIGS. 7 to 9, augmented with an additional small component Δ1, and,

2) F1 further contains two signatures: S1 and S2 that are wired into it. Of these, S2 is a signature over the design of F2, and S1 is a signature over the design of F1 (i.e., F∪Δ1).

3) F2 is a very simple design that is built only to scan or measure the F1 design and build a signature and confirm that it matches S1, and, F2 contains, “wired” within it, the signatures S1 and S2.

4) The additional component Δ1 in F1 is a designed, similarly, to scans F2's design and verify that it matches S2.

By construction thus F2 and F1 are designed to verify each other, and contain within them the signatures that each match the measurement of the other's design.

Also, in an example, the cloud verifier adds a nonce to each design F2 and F1, and installs first the image for F1 with a portion of FPGA left unpopulated as room for F2. The cloud verifier, after the FPGA reports into cloud service, next installs the image for F2. When this is done, the invention is robust to any outage in its link back to the cloud verifier, because F2 and F1 cross-check each other and initiate a reset on the machine when it appears that either F2 or F1 is compromised. Since the two designs are not installed into the FPGA in a single installation step, it is impossible for an invader to compromise both at the same time. The cloud verifier, on the other hand, can arrange to pick a nonce that correctly produces cross-validating end signatures, which an invader cannot easily do without an extraordinary amount of effort.

Hardening 2: For this the cloud verifier designs in two timestamp fields τ1 and τ2 respectively into the FPGA designs F2 and F1 that are described above for hardening 1; however, by design, the timestamps τ1 and τ2 are excluded from the signatures S1 and S2. At each verification step, the two timestamp fields are advanced to current time τ, and three values, V1=signature over (S1⊗τ), V2=(S2⊗τ), and, V3=τ are written into three locations in memory that are under the monitoring of the FPGA design, and are logged into the TMM expected values set. An attempt to compromise and spoof the FPGA based design now has a limited amount of time between any two successive heartbeats sent from the FPGA to the cloud verifier.

### Additional Implementations and Examples

Implementation of the preceding techniques may be accomplished through any number of specifications, configurations, or example deployments of hardware and software. It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Example 1 is a computing system, node, or node embodied as or within a system, comprising: memory circuitry, comprising a dynamic random access memory (DRAM) device; processing circuitry, operably coupled to the DRAM device; and a field programmable gate array (FPGA), the FPGA configured to install and provision a memory monitor, wherein the memory monitor is provided from a verifier entity external to the computing system, and wherein the memory monitor is operated by the FPGA to monitor operations of the DRAM device; wherein the FPGA includes a Root of Trust (RoT) hardware component that is compliant with a Device Identifier Composition Engine (DICE) trusted computing specification, wherein DICE attestation using the RoT hardware component is used to verify a secure state of the memory monitor with the verifier entity, during operation of the memory monitor by the FPGA.

In Example 2, the subject matter of Example 1 optionally includes subject matter where the memory circuitry further comprises a memory controller, and wherein the memory controller includes a RoT hardware component that is compliant with the DICE trusted computing specification.

In Example 3, the subject matter of Example 2 optionally includes subject matter where the memory controller is configured by the FPGA to install and provision a monitor, and wherein the monitor of the memory controller is used to monitor values of the DRAM device.

In Example 4, the subject matter of any one or more of Examples 1-3 optionally include subject matter where the processing circuitry further comprises a system agent hardware component, and wherein the system agent hardware component includes a RoT hardware component that is compliant with the DICE trusted computing specification.

In Example 5, the subject matter of Example 4 optionally includes subject matter where the processing circuitry further comprises at least one cache and at least one processing unit, wherein the system agent hardware component is configured by the FPGA to install and provision a monitor, and wherein the monitor of the system agent hardware component is used to monitor values of the at least one cache and the at least one processing unit.

In Example 6, the subject matter of any one or more of Examples 1-5 optionally include subject matter where the FPGA includes multiple DICE layers which are verified according to the DICE trusted computing specification, wherein the memory monitor is operated at a highest layer of the DICE layers.

In Example 7, the subject matter of any one or more of Examples 1-6 optionally include subject matter where the verifier entity causes the FPGA to verify a signature of a FPGA design for the memory monitor, and install the memory monitor onto the FPGA using the FPGA design.

In Example 8, the subject matter of Example 7 optionally includes subject matter where execution of the memory monitor by the FPGA causes attestation values produced from the RoT hardware component to be provided to the verifier entity, and wherein the verifier entity causes the computing system to reinstall the FPGA design onto the FPGA in response to failure to verify the attestation values.

In Example 9, the subject matter of any one or more of Examples 1-8 optionally include subject matter where execution of the memory monitor causes the memory monitor to collect and verify a state of the DRAM device.

In Example 10, the subject matter of Example 9 optionally includes subject matter where, in response to a failed state of the DRAM device, detected by the memory monitor, the memory monitor enforces a policy associated with the DRAM device.

In Example 11, the subject matter of any one or more of Examples 9-10 optionally include subject matter where, in response to a failed state of the DRAM device, detected by the memory monitor, the memory monitor notifies the verifier entity and a system agent associated with the computing system.

In Example 12, the subject matter of anyone or more of Examples 1-11 optionally include communications circuitry to communicate with the verifier entity, where the verifier entity is operated by a remotely connected computing system, wherein the remotely connected computing system maintains: an image for an FPGA design of the memory monitor, and expected values for attestation from use of the FPGA design.

Example 13 is at least one non-transitory machine-readable storage medium comprising instructions, wherein the instructions, when executed by a computing system, cause the computing system to perform operations to: install and provision a memory monitor on a programmable device of the computing system, wherein the memory monitor is provided from a verifier entity external to the computing system, and wherein the memory monitor is operated by the programmable device to monitor operations of a dynamic random access memory (DRAM) device of the computing system; and perform attestation using a RoT hardware component of the programmable device, wherein the attestation is used to verify a secure state of the memory monitor with the verifier entity, during operation of the memory monitor; wherein the RoT hardware component of the programmable device is compliant with a Device Identifier Composition Engine (DICE) trusted computing specification, and wherein the attestation comprises DICE attestation operations.

In Example 14, the subject matter of Example 13 optionally includes subject matter where the DRAM device further comprises a memory controller, and wherein the memory controller includes a RoT hardware component that is compliant with the DICE trusted computing specification.

In Example 15, the subject matter of Example 14 optionally includes subject matter where the memory controller is configured by the programmable device to install and provision a monitor, and wherein the monitor of the memory controller is used to monitor values of the DRAM device.

In Example 16, the subject matter of any one or more of Examples 13-15 optionally include subject matter where the computing system comprises processing circuitry having a system agent hardware component, wherein the system agent hardware component includes a RoT hardware component that is compliant with the DICE trusted computing specification; and wherein the processing circuitry further comprises at least one cache and at least one processing unit, wherein the system agent hardware component is configured by the programmable device to install and provision a monitor, and wherein the monitor of the system agent hardware component is used to monitor values of the at least one cache and the at least one processing unit.

In Example 17, the subject matter of any one or more of Examples 13-16 optionally include subject matter where the programmable device includes multiple DICE layers which are verified according to the DICE trusted computing specification, wherein the memory monitor is operated at a highest layer of the DICE layers.

In Example 18, the subject matter of any one or more of Examples 13-17 optionally include subject matter where the verifier entity causes the programmable device to verify a signature of a programmable device design for the memory monitor, and install the memory monitor onto the programmable device using the programmable device design.

In Example 19, the subject matter of Example 18 optionally includes subject matter where execution of the memory monitor by the programmable device causes attestation values produced from the RoT hardware component to be provided to the verifier entity, and wherein the verifier entity causes the computing system to reinstall the programmable device design onto the programmable device in response to failure to verify the attestation values.

In Example 20, the subject matter of any one or more of Examples 13-19 optionally include subject matter where execution of the memory monitor causes the memory monitor to collect and verify a state of the DRAM device.

In Example 21, the subject matter of Example 20 optionally includes subject matter where, in response to a failed state of the DRAM device, detected by the memory monitor, the memory monitor enforces a policy associated with the DRAM device.

In Example 22, the subject matter of any one or more of Examples 20-21 optionally include subject matter where, in response to a failed state of the DRAM device, detected by the memory monitor, the memory monitor notifies the verifier entity and a system agent associated with the computing system.

In Example 23, the subject matter of any one or more of Examples 13-22 optionally include subject matter where the verifier entity is operated by a remotely connected computing system, wherein the remotely connected computing system maintains: an image for a programmable device design of the memory monitor, and expected values for attestation from use of the programmable device design.

In Example 24, the subject matter of any one or more of Examples 13-23 optionally include subject matter where the programmable device is a field programmable gate array (FPGA) or an Application-specific integrated circuit (ASIC) device.

Example 25 is a computing apparatus comprising: a dynamic random access memory (DRAM) device; a programmable device; means for installing and provisioning a memory monitor on the programmable device, wherein the memory monitor is provided from a verifier entity external to the computing apparatus, and wherein the memory monitor is operated by the programmable device to monitor operations of the DRAM device; and means for performing attestation using a root of trust (RoT) of the programmable device, wherein the attestation is used to verify a secure state of the memory monitor with the verifier entity, during operation of the memory monitor: wherein the RoT of the programmable device is compliant with a Device Identifier Composition Engine (DICE) trusted computing specification, and wherein the attestation comprises DICE attestation operations.

In Example 26, the subject matter of Example 25 optionally includes means for hardening attestation operations performed by the memory monitor.

Example 27 is a system, comprising: a computing device, configured according to any of Examples 1-12; and a verifier computing system, wherein the verifier computing system is configured to operate as an external entity according to any of Examples 1-12.

In Example 28, the subject matter of Example 27 optionally includes subject matter where the external entity provides an image of a memory monitor for installation at a FPGA, and wherein the external entity includes expected values used to verify the secure state of the memory monitor.

In Example 29, the subject matter of Example 28 optionally includes subject matter where attestation operations performed by the computing device are hardened.

In Example 30, the subject matter of any one or more of Examples 28-29 optionally include subject matter where the verifier computing system operates as an orchestrator of a plurality of computing systems.

Example 31 is a method, performed using circuitry of a computing device, comprising: install and provision a memory monitor on a programmable device of the computing device, wherein the memory monitor is provided from a verifier entity external to the computing device, and wherein the memory monitor is operated by the programmable device to monitor operations of a dynamic random access memory (DRAM) device of the computing device; and perform attestation using a RoT hardware component of the programmable device, wherein the attestation is used to verify a secure state of the memory monitor with the verifier entity, during operation of the memory monitor; wherein the RoT hardware component of the programmable device is compliant with a Device Identifier Composition Engine (DICE) trusted computing specification, and wherein the attestation comprises DICE attestation operations.

In Example 32, the subject matter of Example 31 optionally includes subject matter where the DRAM device further comprises a memory controller, and wherein the memory controller includes a RoT hardware component that is compliant with the DICE trusted computing specification.

In Example 33, the subject matter of Example 32 optionally includes subject matter where the memory controller is configured by the programmable device to install and provision a monitor, and wherein the monitor of the memory controller is used to monitor values of the DRAM device.

In Example 34, the subject matter of anyone or more of Examples 31-33 optionally include subject matter where the computing device comprises processing circuitry having a system agent hardware component, wherein the system agent hardware component includes a RoT hardware component that is compliant with the DICE trusted computing specification; and wherein the processing circuitry further comprises at least one cache and at least one processing unit, wherein the system agent hardware component is configured by the programmable device to install and provision a monitor, and wherein the monitor of the system agent hardware component is used to monitor values of the at least one cache and the at least one processing unit.

In Example 35, the subject matter of any one or more of Examples 31-34 optionally include subject matter where the programmable device includes multiple DICE layers which are verified according to the DICE trusted computing specification, wherein the memory monitor is operated at a highest layer of the DICE layers.

In Example 36, the subject matter of anyone or more of Examples 31-35 optionally include subject matter where the verifier entity causes the programmable device to verify a signature of a programmable device design for the memory monitor, and install the memory monitor onto the programmable device using the programmable device design.

In Example 37, the subject matter of Example 36 optionally includes subject matter where execution of the memory monitor by the programmable device causes attestation values produced from the RoT hardware component to be provided to the verifier entity, and wherein the verifier entity causes the computing device to reinstall the programmable device design onto the programmable device in response to failure to verify the attestation values.

In Example 38, the subject matter of anyone or more of Examples 31-37 optionally include subject matter where execution of the memory monitor causes the memory monitor to collect and verify a state of the DRAM device.

In Example 39, the subject matter of Example 38 optionally includes subject matter where, in response to a failed state of the DRAM device, detected by the memory monitor, the memory monitor enforces a policy associated with the DRAM device.

In Example 40, the subject matter of any one or more of Examples 38-39 optionally include subject matter where, in response to a failed state of the DRAM device, detected by the memory monitor, the memory monitor notifies the verifier entity and a system agent associated with the computing device.

In Example 41, the subject matter of anyone or more of Examples 31-40 optionally include subject matter where the verifier entity is operated by a remotely connected computing system, wherein the remotely connected computing system maintains: an image for a programmable device design of the memory monitor, and expected values for attestation from use of the programmable device design.

In Example 42, the subject matter of any one or more of Examples 31-41 optionally include subject matter where the programmable device is a field programmable gate array (FPGA) or an Application-specific integrated circuit (ASIC) device.

Another example implementation is an edge computing system, including respective edge processing devices and nodes configured or operated according to Examples 1-42, or other subject matter described herein.

Another example implementation is a client endpoint node, configured or operated according to Examples 1-42, or other subject matter described herein.

Another example implementation is an aggregation node, network hub node, gateway node, or core data processing node, within or coupled to an edge computing system, configured or operated according to Examples 1-42, or other subject matter described herein.

Another example implementation is an access point, base station, roadside unit, street-side unit, or on-premise unit, within or coupled to an edge computing system, configured or operated according to Examples 1-42, or other subject matter described herein.

Another example implementation is an edge provisioning node, service orchestration node, application orchestration node, or multi-tenant management node, within or coupled to an edge computing system, configured or operated according to Examples 1-42, or other subject matter described herein.

Another example implementation is an apparatus of an edge computing system comprising: one or more processors and one or more computer-readable media comprising instructions that, when executed by the one or more processors, cause the one or more processors to invoke or perform the use cases discussed herein, with use of Examples 1-42, or other subject matter described herein.

Another example implementation is one or more computer-readable storage media comprising instructions to cause an electronic device of an edge computing system, upon execution of the instructions by one or more processors of the electronic device, to invoke or perform the use cases discussed herein, with use of Examples 1-42, or other subject matter described herein.

Another example implementation is an apparatus of an edge computing system comprising means, logic, modules, or circuitry to invoke or perform the use cases discussed herein, with use of Examples 1-42, or other subject matter described herein.

Although these implementations have been described with reference to specific exemplary aspects, it will be evident that various modifications and changes may be made to these aspects without departing from the broader scope of the present disclosure. This Detailed Description, therefore, is not to be taken in a limiting sense, and the scope of various aspects is defined only by the appended claims, along with the full range of equivalents to which such claims are entitled.

What is claimed is:

1. A computing node, comprising:
memory circuitry, comprising a dynamic random access memory (DRAM) device;
processing circuitry, operably coupled to the DRAM device; and
a field programmable gate array (FPGA), the FPGA configured to install and provision a memory monitor, wherein the memory monitor is provided from a verifier entity external to the computing node, and wherein the memory monitor is operated by the FPGA to monitor operations of the DRAM device;
wherein the FPGA includes a Root of Trust (RoT) hardware component that is compliant with a Device Identifier Composition Engine (DICE) trusted computing specification, wherein DICE attestation using the RoT hardware component is used to verify a secure state of the memory monitor with the verifier entity, during operation of the memory monitor by the FPGA.

2. The computing node of claim 1, wherein the memory circuitry further comprises a memory controller, and wherein the memory controller includes a RoT hardware component that is compliant with the DICE trusted computing specification.

3. The computing node of claim 2, wherein the memory controller is configured by the FPGA to install and provision a monitor, and wherein the monitor of the memory controller is used to monitor values of the DRAM device.

4. The computing node of claim 1, wherein the processing circuitry further comprises a system agent hardware component, and wherein the system agent hardware component includes a RoT hardware component that is compliant with the DICE trusted computing specification.

5. The computing node of claim 4, wherein the processing circuitry further comprises at least one cache and at least one processing unit, wherein the system agent hardware component is configured by the FPGA to install and provision a monitor, and wherein the monitor of the system agent hardware component is used to monitor values of the at least one cache and the at least one processing unit.

6. The computing node of claim 1, wherein the FPGA includes multiple DICE layers which are verified according to the DICE trusted computing specification, wherein the memory monitor is operated at a highest layer of the DICE layers.

7. The computing node of claim 1, wherein the verifier entity causes the FPGA to verify a signature of an FPGA design for the memory monitor and install the memory monitor onto the FPGA using the FPGA design.

8. The computing node of claim 7, wherein execution of the memory monitor by the FPGA causes attestation values produced from the RoT hardware component to be provided to the verifier entity, and wherein the verifier entity causes the computing node to reinstall the FPGA design onto the FPGA in response to failure to verify the attestation values.

9. The computing node of claim 1, wherein execution of the memory monitor causes the memory monitor to collect and verify a state of the DRAM device.

10. The computing node of claim 9, wherein, in response to a failed state of the DRAM device, detected by the memory monitor, the memory monitor enforces a policy associated with the DRAM device.

11. The computing node of claim 9, wherein, in response to a failed state of the DRAM device, detected by the memory monitor, the memory monitor notifies the verifier entity and a system agent associated with the computing node.

12. The computing node of claim 1, further comprising:
communications circuitry to communicate with the verifier entity;
wherein the verifier entity is operated by a remotely connected computing system, wherein the remotely connected computing system maintains: an image for an FPGA design of the memory monitor, and expected values for attestation from use of the FPGA design.

13. At least one non-transitory machine-readable storage medium comprising instructions, wherein the instructions, when executed by a computing system, cause the computing system to perform operations to:
install and provision a memory monitor on a programmable device of the computing system, wherein the memory monitor is provided from a verifier entity external to the computing system, and wherein the memory monitor is operated by the programmable device to monitor operations of a dynamic random access memory (DRAM) device of the computing system; and
perform attestation using a RoT hardware component of the programmable device, wherein the attestation is used to verify a secure state of the memory monitor with the verifier entity, during operation of the memory monitor;
wherein the RoT hardware component of the programmable device is compliant with a Device Identifier Composition Engine (DICE) trusted computing specification, and wherein the attestation comprises DICE attestation operations.

14. The machine-readable medium of claim 13, wherein the DRAM device further comprises a memory controller, and wherein the memory controller includes a RoT hardware component that is compliant with the DICE trusted computing specification.

15. The machine-readable medium of claim 14, wherein the memory controller is configured by the programmable device to install and provision a monitor, and wherein the monitor of the memory controller is used to monitor values of the DRAM device.

16. The machine-readable medium of claim 13, wherein the computing system comprises processing circuitry having a system agent hardware component, wherein the system agent hardware component includes a RoT hardware component that is compliant with the DICE trusted computing specification; and
wherein the processing circuitry further comprises at least one cache and at least one processing unit, wherein the system agent hardware component is configured by the programmable device to install and provision a monitor, and wherein the monitor of the system agent hardware component is used to monitor values of the at least one cache and the at least one processing unit.

17. The machine-readable medium of claim 13, wherein the programmable device includes multiple DICE layers which are verified according to the DICE trusted computing specification, wherein the memory monitor is operated at a highest layer of the DICE layers.

18. The machine-readable medium of claim 13, wherein the verifier entity causes the programmable device to verify a signature of a programmable device design for the memory monitor, and install the memory monitor onto the programmable device using the programmable device design.

19. The machine-readable medium of claim 18, wherein execution of the memory monitor by the programmable device causes attestation values produced from the RoT hardware component to be provided to the verifier entity, and wherein the verifier entity causes the computing system to reinstall the programmable device design onto the programmable device in response to failure to verify the attestation values.

20. The machine-readable medium of claim 13, wherein execution of the memory monitor causes the memory monitor to collect and verify a state of the DRAM device, and
wherein, in response to a failed state of the DRAM device, detected by the memory monitor, the memory monitor:
enforces a policy associated with the DRAM device; or
notifies the verifier entity and a system agent associated with the computing system.

21. The machine-readable medium of claim 13, wherein the verifier entity is operated by a remotely connected computing system, wherein the remotely connected computing system maintains: an image for a programmable device design of the memory monitor, and expected values for attestation from use of the programmable device design.

22. The machine-readable medium of claim 13, wherein the programmable device is a field programmable gate array (FPGA) or an Application-specific integrated circuit (ASIC) device.

23. A programmable device, comprising:
circuitry configured to install and provision a memory monitor, wherein the memory monitor is provided from a verifier entity, and wherein the memory monitor is operated by the programmable device to monitor operations of a memory device; and
a Root of Trust (RoT) hardware component that is compliant with a Device Identifier Composition Engine (DICE) trusted computing specification, wherein DICE attestation using the RoT hardware component is used to verify a secure state of the memory monitor with the verifier entity, during operation of the memory monitor by the programmable device.

24. The programmable device of claim 23, wherein the circuitry comprises field programmable gate array (FPGA) or an Application-specific integrated circuit (ASIC) circuitry.

25. The programmable device of claim 23, wherein the programmable device includes multiple DICE layers which are verified according to the DICE trusted computing specification, wherein the memory monitor is operated at a highest layer of the DICE layers.
